(19) United States
(12) Patent Application Publication
(10) Pub. No.: US 2022/0256583 A1
(43) Pub. Date: Aug. 11, 2022

(54) TERMINAL AND METHOD PERFORMED BY THE SAME

(71) Applicant: Samsung Electronics Co., Ltd., Gyeonggi-do (KR)

(72) Inventors: Yi WANG, Beijing (CN); Feifei Sun, Beijing (CN)

(21) Appl. No.: 17/589,170

(22) Filed: Jan. 31, 2022

(30) Foreign Application Priority Data
Feb. 5, 2021 (CN) 202110164809.8

(51) Int. Cl. H04W 72/12; H04W 72/04

(52) U.S. Cl. CPC H04W 72/1289; H04W 72/0413; H04W 72/0453

(57) ABSTRACT

A terminal and a method performed by the terminal are disclosed. The method includes receiving configuration information of a first frequency-domain transmission resource and a second frequency-domain transmission resource, where the first frequency-domain transmission resource and the second frequency-domain transmission resource partially overlap or completely overlap in time domain, and determining whether to perform an uplink transmission and/or downlink reception on the first frequency-domain transmission resource and/or the second frequency-domain transmission resource based on the configuration information, to provide a solution to the collision problem between transmission directions on different frequency-domain transmission resources.

### CROSS-REFERENCE TO RELATED APPLICATION(S)

This application is based on and claims priority under 35 U.S.C. § 119(a) to Chinese Patent Application No. 202110164809.8, filed on Feb. 5, 2021, in the China National intellectual Property Administration, the disclosure of which is incorporated by reference herein in its entirety.

### BACKGROUND

### 1. Field

The present disclosure generally relates to the field of wireless communication, and in particular, to a terminal and a method performed by the same.

### 2. Description of Related Art

5G mobile communication technologies define broad frequency bands such that high transmission rates and new services are possible, and can be implemented not only in “Sub 6 GHz” bands such as 3.5GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile Broadband (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of IMP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service,

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IA13 (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (IML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, meta material-based lenses and antennas for improving coverage of terahertz band signals, high-dimensional space multiplexing technology using OMA (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid frequency shift keying (FSK) and quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies, have been developed.

### SUMMARY

According to an embodiment, a method performed by a terminal is provided. The method includes receiving configuration information of a first frequency-domain transmission resource and a second frequency-domain transmission resource, where the first frequency-domain transmission resource and the second frequency-domain transmission resource partially overlap or completely overlap in a time domain; and determining whether to perform at least one of an uplink transmission or a downlink reception on the first frequency-domain transmission resource or the second frequency-domain transmission resource based on the configuration information.

According to an embodiment, a terminal is also provided. The terminal includes a transceiver configured to transmit and receive signals; and a controller coupled to the transceiver and configured to receive configuration information of a first frequency-domain transmission resource and a second frequency-domain transmission resource, where the first frequency-domain transmission resource and the second frequency-domain transmission resource partially overlap or completely overlap in time domain; and determine whether to perform at least one of an uplink transmission or a downlink reception on the first frequency-domain transmission resource or the second frequency-domain transmission resource based on the configuration information.

According to an embodiment, a computer-readable storage medium having one or more computer programs stored thereon is also provided, where the one or more computer programs, when executed by one or more processors, can control receiving configuration information of a first frequency-domain transmission resource and a second frequency-domain transmission resource, wherein the first frequency-domain transmission resource and the second frequency-domain transmission resource partially overlap or completely overlap in a time domain; and control determining whether to perform at least one of an uplink transmission or a downlink reception on the first frequency-domain transmission resource or the second frequency-domain transmission resource based on the configuration information.

### BRIEF DESCRIPTION OF THE DRAWINGS

In order to illustrate the technical schemes of the embodiments of the present disclosure more clearly, the drawings of the embodiments will be briefly introduced below. The drawings described below may refer to only some embodiments, and do not limit the present disclosure. In the drawings:

FIG. 1 illustrates a schematic diagram of a wireless network according to an embodiment;

FIGS. 2A and 2B illustrate wireless transmission and reception paths according to an embodiment;

FIG. 3A illustrates a user equipment (UE) according to an embodiment;

FIG. 3B illustrates a gNB according to an embodiment;

FIG. 4A illustrates a schematic diagram of uplink-downlink resource allocation according to an embodiment;

FIG. 4B illustrates a schematic diagram of uplink-downlink resource allocation according to an embodiment;

FIG. 5 illustrates a flowchart of a method performed by a UE according to an embodiment;

FIG. 6 illustrates a flowchart of a method performed by a terminal according to an embodiment;

FIG. 7 illustrates a method performed by a base station according to an embodiment;

FIG. 8 illustrates a block diagram of a configuration of a terminal according to an embodiment; and

FIG. 9 illustrates a block diagram of a configuration of a base station according to an embodiment.

### DETAIUED DESCRIPTION

In order to make the purpose, technical schemes and advantages of the embodiments of the present disclosure clearer, the technical schemes of the embodiments will be described clearly and completely with reference to the drawings. The described embodiments are a part of the embodiments, but not all embodiments. Based on the described embodiments, all other embodiments obtained by those of ordinary skill in the art without creative labor belong to the protection scope of the present disclosure.

Before undertaking the detailed description below, it can be advantageous to set forth definitions of certain words and phrases used herein. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A., B, and C” includes any of the following combinations: A, B, C, A and B, A and C, B and C, and A and B and C. For example, “at least one of: A, B, or C” includes any of the following combinations: A, B, C, A and B, A and C, B and C, and A and B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments are not intended to limit and/or define the scope of the present disclosure. For example, unless otherwise defined, the technical terms or scientific terms used in the present disclosure shall have the ordinary meaning understood by those with ordinary skills in the art to which the present disclosure belongs.

It should be understood that “first”, “second” and similar words used in the present disclosure do not express any order, quantity or importance, but are only used to distinguish different components. Unless otherwise indicated by the context clearly, similar words such as “a”, “an” or “the” in a singular form do not express a limitation of quantity, but express an existence of at least one.

As used herein, any reference to “one example” or “example”, and “one embodiment” or “embodiment” means that particular elements, features, structures or characteristics described in connection with the embodiment is included in at least one embodiment. The phrases “in one embodiment” or “in one example” appearing in different places do not necessarily refer to the same embodiment.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the present disclosure herein are for illustration purposes only and should not be interpreted as limiting the scope of the present disclosure in any way. Those skilled in the art will understand that the principles of the present disclosure can be implemented in any suitably arranged wireless communication system. For example, although the following detailed description of the embodiments of the present disclosure will be directed to UE and/or 5G, those skilled in the art can understand that the main points of the present disclosure can also be applied to other communication systems with similar technical backgrounds and channel formats with slight modifications without departing from the scope of the present disclosure.

In the description of the present disclosure, when it is considered that some detailed explanations about functions or configurations may unnecessarily obscure the essence of the present disclosure, these detailed explanations will be omitted. All terms (including descriptive or technical terms) used herein should be interpreted as having meanings apparent to those of ordinary skill in the art. However, these terms may have different meanings according to the intention of those of ordinary skill in the art, precedents or the emergence of new technologies, and therefore, the terms used herein must be defined based on the meanings of these terms together with the description provided herein. Hereinafter, for example, the base station may be at least one of a gNode B, an eNode B, a Node B, a radio access unit, a base station controller, and a node on a network. The terminal may include a user equipment (UE), a mobile station (MS), a mobile phone, a smart phone, a computer or multimedia system capable of performing communication functions. In some embodiments of the present disclosure, the downlink (DL) is a wireless transmission path through which signals are transmitted from a base station to a terminal, and the uplink (UL) is a wireless transmission path through which signals are transmitted from a terminal to a base station. In addition, one or more embodiments may be applied to 5G wireless communication technologies (5G, new radio (NR)) developed after UE-A, or to new wireless communication technologies proposed on the basis of 4G or 5G (for example, B5G (beyond 5G) or 6G).

Hereinafter, the embodiments of the present disclosure will be described in detail with reference to the accompanying drawings. It should be noted that the same reference numerals in different drawings will be used to refer to the same elements already described.

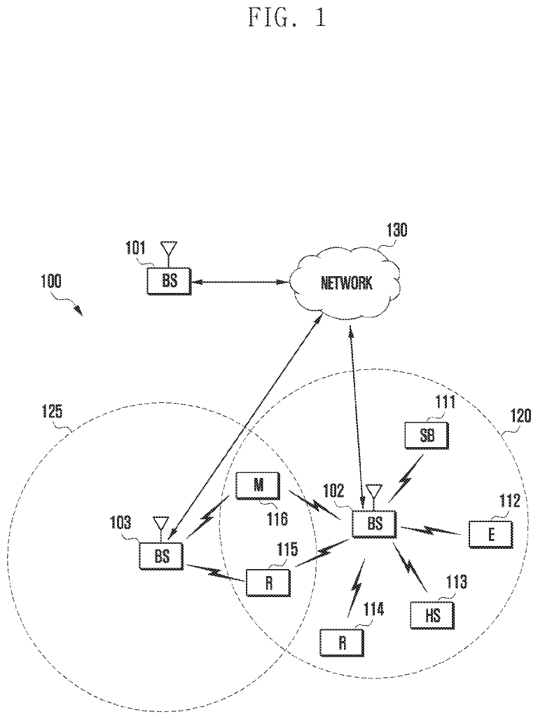

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the present disclosure may be implemented in any suitably arranged communication systems.

FIG. 1 illustrates a wireless network 100 according to an embodiment.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used herein to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used herein to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103 The second plurality of UEs include a UE 115 and a UE 116. In some embodiments, one or more of gNBs 101-103 can communicate with each other and with UEs 111-116 using 5G, long term evolution (UE), UE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two dimensional (2D) antenna array as described in embodiments of the present disclosure. One or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

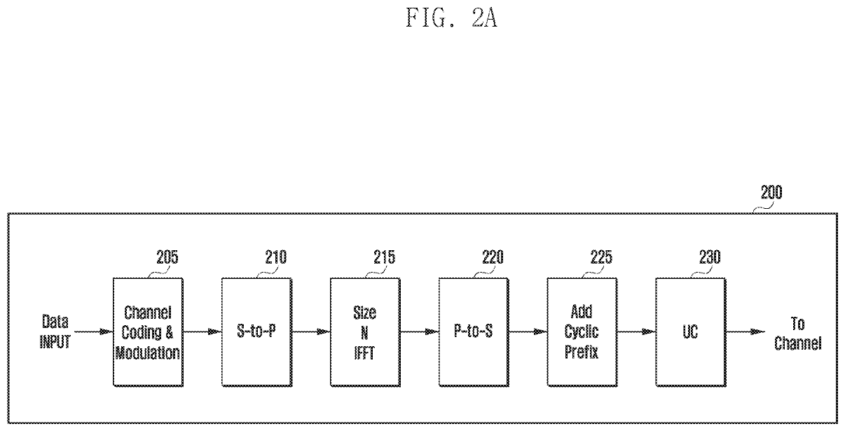

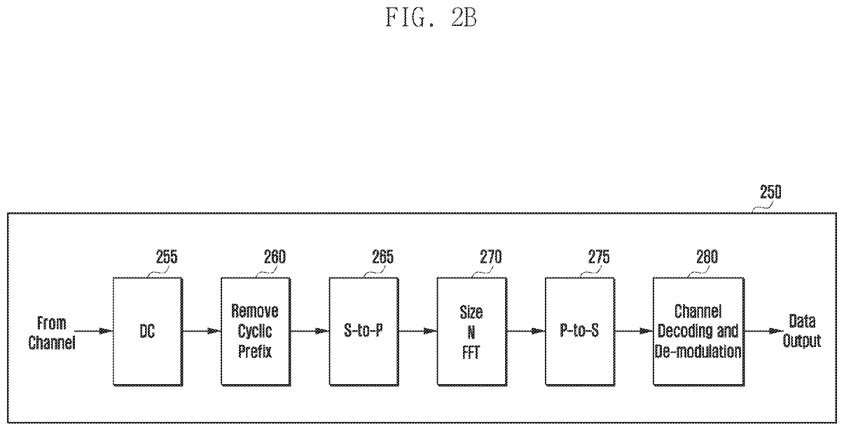

FIGS. 2A and 2B illustrate wireless transmission and reception paths according to an embodiment. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. The reception path 250 is configured to support codebook designs and structures for systems with 2D antenna arrays as described in embodiment.

As shown in FIG. 2A, the transmission path 200 includes a channel coding and modulation block 205, a serial-to-parallel (S-to-P) block 210, a size N inverse fast Fourier transform (IFFT) block 215, a Parallel-to-serial (P-to-S) block 220, a cyclic prefix addition block 225, and an up-converter (UC) 230, As shown in FIG. 2B, the reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or QAM to generate a sequence of frequency-domain modulated symbols. The S-to-P block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The P-to-S block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As an example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

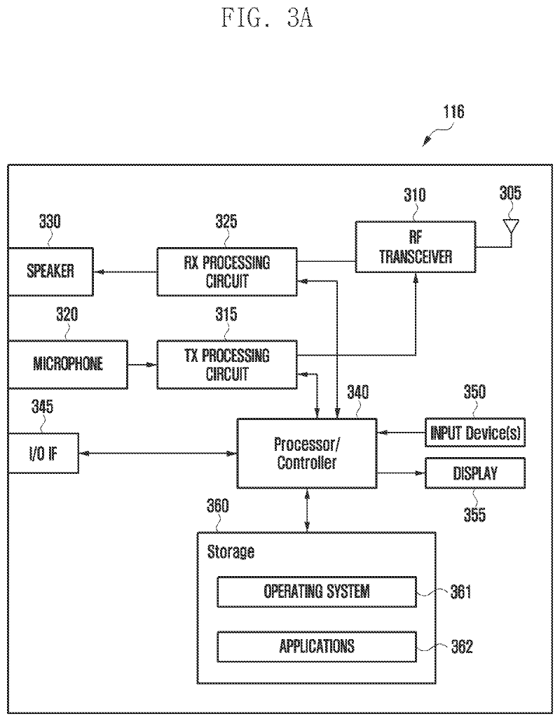

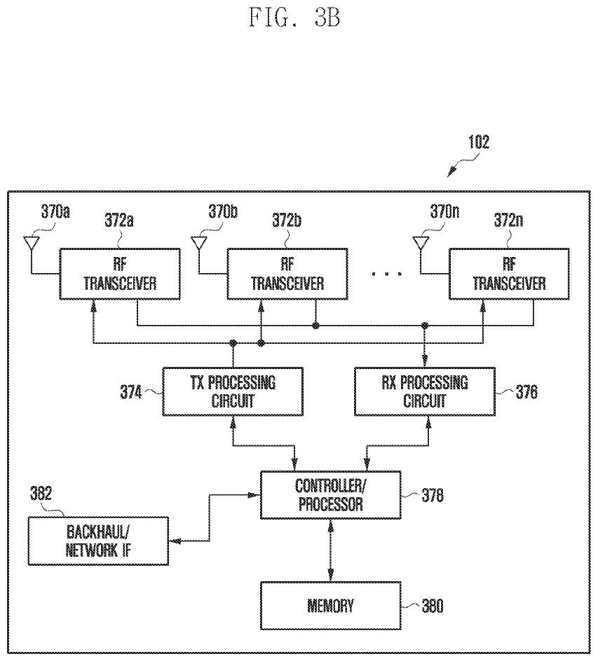

FIG. 3A illustrates a UE 116 according to an embodiment. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340, The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. The processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As an example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates a gNB 102 according to an embodiments. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. One or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in gNB 102, The controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays. The controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, UE or UE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory, The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As an example, the access point can include many backhaul or network interfaces 382, and the controller/processor 378 can support routing functions to route data between different network addresses. As another example, although shown as including a single instance of the TX processing circuit 374 and a single instance of the RX processing circuit 376, gNB 102 can include multiple instances of each (such as one for each RF transceiver). Communication systems (e.g., UE, UE-A, or NR systems) may support not only a frequency division duplexing (FDD) scheme, but also a time division duplexing (TDD) scheme. For the FDD scheme, separate frequencies are used for uplink and downlink. For the TDD scheme, transmission and reception of uplink signals and downlink signals are divided in time domain, but the uplink and downlink use common frequencies.

In order to improve the utilization of carriers with a small bandwidth (BW) or promote communication on different carrier frequencies, communication systems may include aggregation of several carriers corresponding to different cells. In carrier aggregation (CA), each carrier represents a cell (which may also be referred to as a serving cell), and each cell may be classified into a primary cell (Pcell) or a secondary cell (Scell). The primary cell may provide basic radio resources to a UE, i.e., a basic cell in which the UE performs operations such as initial access and handover. Meanwhile, the secondary cell may provide additional radio resources to the UE. In dual connectivity (DC), the UE may be configured with a primary cell of a master eNB (MeNB) and a primary secondary cell (PScell) of a secondary eNB (SeNB). Throughout the disclosure, the terms “carrier”, “cell” and “serving cell” may be used interchangeably.

Generally, on respective frequency-domain transmission resources (e.g., carriers) in the same band, a base station uses the same uplink-downlink configuration to avoid mutual interference between uplink and downlink of different frequency-domain transmission resources (e.g., carriers) in the same band, For a UE operating in an intra-band CA of a TDD band, at any time, the UE will only receive in or transmit in one or more frequency-domain transmission resources (e.g., carriers) of the TDD band. However, in the case that the UE receives in one frequency-domain transmission resource (e.g., carrier), transmission in another frequency-domain transmission resource (e.g., carrier) at the same time will not occur.

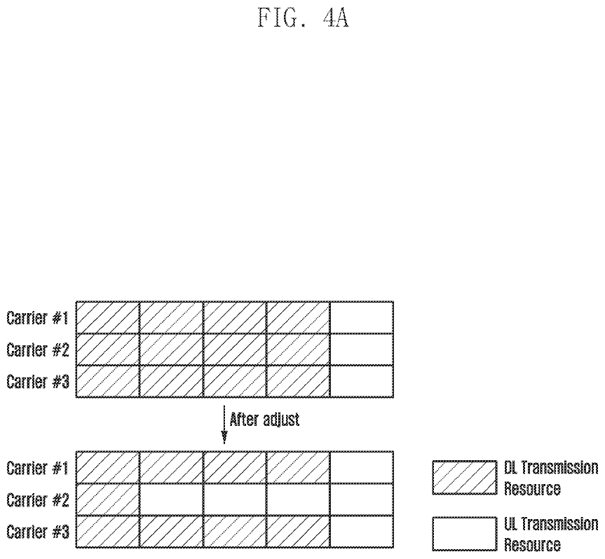

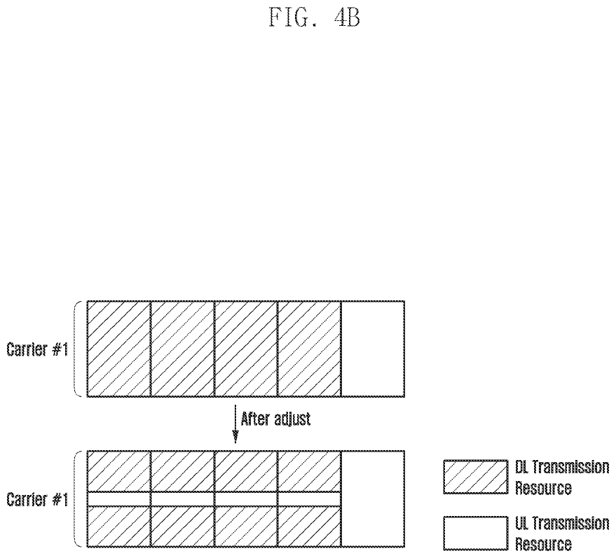

In order to expand the uplink coverage, shorten the time delay of uplink transmission and improve the uplink capacity, resources used for uplink transmission and downlink transmission in spectrum resources may be adjusted according to traffic demands. FIG. 4A illustrates a schematic diagram of uplink-downlink resource allocation according to an embodiment, and FIG. 4B illustrates a schematic diagram of uplink-downlink resource allocation according to an embodiment.

In some cases, in one TDD band, uplink-downlink configurations on respective frequency-domain transmission resources (e.g., carriers) may be different. For example, as shown in FIG. 4A, uplink-downlink configurations for carrier #1, carrier #2 and carrier #3 are different. In these cases, spectrum resources used for uplink transmission and downlink transmission may be adjusted, for example, by changing a number of symbols used for the uplink transmission. For example, by increasing uplink symbols of at least one carrier (e.g., carrier #2), the uplink transmission performance of the system is improved, and the downlink transmission rate is guaranteed by sufficient downlink resources in other cells. In these cases, how to perform uplink transmission and a downlink reception by the UE, and how to reduce the mutual interference between uplink and downlink of different frequency-domain transmission resources (e.g., carriers) are problems to be solved.

In some other cases, in one carrier, uplink-downlink transmission resources are allocated on the different frequency-domain transmission resources (e.g., different bandwidth parts (BWPs) or different resource block (RB) sets) or on the same frequency-domain transmission resources (e.g., the same BWP or the same RB set). For example, as shown in FIG. 4B, in a symbol, an intermediate part of the carrier (e.g., carrier #1) is the uplink transmission resource, and two sides of the carrier (e.g., carrier #1) are the downlink transmission resources, In these cases, the uplink transmission performance of the system is improved by the intermediate uplink transmission resources, and at the same time, the downlink transmission rate is guaranteed by the downlink transmission resources on the two sides. In these cases, how to perform an uplink transmission and downlink reception by the UE, and how to reduce the mutual interference between uplink and downlink of the different frequency-domain transmission resources (e.g., different BWPs or RB sets in the carriers) are problems to be solved.

The consideration of the collision problem between transmission directions on different frequency-domain transmission resources is described above, for example, the collision problem between transmission directions on different carriers in a band. Similarly, for example, it is necessary to consider the collision problem of transmission directions on different carrier groups in a band. For another example, it is necessary to consider the collision problem between transmission directions on different BWPs in a band. For yet another example, it is necessary to consider the collision problem between transmission directions on different RB sets in a band. In addition, it is also necessary to consider the collision problem of transmission directions on different carriers between bands. To at least solve the above problems, embodiments of the present disclosure provide a method performed by a UE and the UE.

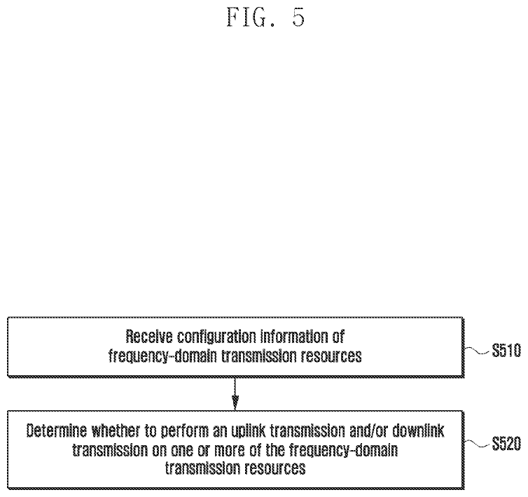

FIG. 5 illustrates a flowchart of a method performed by a UE according to an embodiment.

Referring to FIG. 5, in step S510, configuration information of frequency-domain transmission resources is received. For example, the configuration information may indicate a configuration for one or more of the frequency-domain transmission resources. In an example, the configuration for the frequency-domain transmission resources may include at least one of: (a) time and frequency-domain resource information for uplink transmission, (b) time and frequency-domain resource information for downlink transmission, or (c) time and frequency-domain resource information for flexible transmission.

In some implementations, the configuration information of the frequency-domain transmission resources may include at least one of:
(1) semi-statically indicated uplink-downlink resource configuration information: for example, symbol information of uplink/downlink/flexible transmission indicated by higher layer signaling (such as tdd-UL-DL-ConfigurationCommon and/or UL-DL-ConfigurationDedicated), or time and frequency-domain resource information of uplink/downlink/flexible transmission indicated by specific system information or UE-specific information;
(2) semi-statically indicated uplink-downlink signal transmission information: for example, time resource information (e.g., cycle, offset, etc.) of a downlink channel or a signal configured by the higher layer, or time resource information of an uplink channel and/or an uplink signal configured by the higher layer;
(3) dynamically indicated uplink-downlink resource configuration information: for example, a slot format indicator (SFI) in downlink control information (DCI) format 2_0, or symbol information dynamically indicating uplink/downlink/flexible transmission;
(4) dynamically indicated downlink pre-emption or uplink cancellation information: for example, DL pre-emption by DCI format 2_1 or UL cancellation by DCI format 2_4;
(5) dynamically indicated uplink-downlink signal transmission information: for example, time resource information of an aperiodic channel state information reference signal (CSI-RS), a sounding reference signal (SRS) etc., triggered by physical downlink control channel (PDCCH), or time resource information of physical downlink shared channel (PDSCH)/physical uplink shared channel (PUSCH) etc., scheduled by PDCCH.

In some implementations, the symbol information may include a slot format. For example, the slot format may include a downlink symbol, an uplink symbol and/or a flexible symbol. For example, based on the configuration information of the frequency-domain transmission resources (the symbol information of the uplink/downlink/flexible transmission indicated by the higher layer signaling such as the tdd-UL-DL-ConfigurationCommon and/or the tdd-UL-DL-ConfigurationDedicated), the UE may set a slot format of each slot on multiple slots.

In some implementations, the UE may obtain the configuration information of the frequency-domain transmission resources from the base station through system information or higher layer signaling. The higher layer signaling may include, for example, RRC (radio resource control) signaling and/or MAC (media access control) signaling.

In some implementations, the UE may obtain the configuration information of the frequency-domain transmission resources from the base station through physical layer signaling, The physical layer signaling may include DCI carried by PDCCH and/or control signaling carried by PDSCH.

In step S520, whether to perform an uplink transmission and/or downlink transmission in one or more of the frequency-domain transmission resources is determined. For example, the UE may determine to perform the uplink and/or downlink transmission in a frequency-domain transmission resource according to predefined (or preset) rules and the received configuration information of the frequency-domain transmission resources.

If the UE is configured to perform transmission in multiple frequency-domain transmission resources, and transmission directions in the multiple frequency-domain transmission resources may collide, some UEs may perform transmission in the multiple frequency-domain transmission resources at the same time, that is, it may support receiving and transmitting simultaneously on different frequency-domain transmission resources in a time resource. For convenience of description, a UE that supports receiving and transmitting simultaneously on different frequency-domain transmission resources in a time resource may be referred to as a first type of UE. The other UEs can only perform transmission in one direction (uplink transmission or downlink reception) on the multiple frequency-domain transmission resources at the same time, that is, they can only receive at the same time, or transmit at the same time, but cannot receive and transmit simultaneously on different frequency-domain transmission resources in a time resource. A UE that can only perform transmission in one direction on the multiple frequency-domain transmission resources at the same time may be referred to as a second type of UE. For the second type of UE, it is necessary to determine whether to perform transmission or reception in a time resource. For example, the performing of the transmission or reception in a time resource may be determined according to predefined (or preset) rules.

In some implementations, the frequency-domain transmission resources may include carriers, or carrier groups, or BWPs, or RB sets. For convenience of description, it is described in terms of carriers. However, the embodiments of the present disclosure are not limited to this, and the frequency-domain transmission resources may refer to any other suitable frequency-domain transmission resources, such as carrier groups, BWPs, RB sets, etc. For the sake of brevity, some of the following embodiments may be described based on the frequency-domain transmission resources being carriers. However, those skilled in the art will understand that the frequency-domain transmission resource “carrier” in these embodiments may be replaced by “carrier group”, may be replaced by BWP, or may be replaced by RB set

A transmission may refer to transmitting or receiving. For example, from the perspective of a base station, a downlink transmission may mean that the base station transmits downlink signals, and an uplink transmission may mean that the base station receives uplink signals. For another example, from the perspective of a UE, a downlink transmission may mean that the UE receives downlink signals, and an uplink transmission may mean that the UE transmits uplink signals.

A downlink channel or signal configured by higher layer may include at least one of a PDCCH, a PDSCH, or a CSI-RS, a synchronization signal/physical broadcast channel (SS/PBCH).

An uplink channel and/or an uplink signal configured by higher layer may include at least one of a Physical Uplink Control Channel (PUCCH), a PUSCH, an SRS, or a Physical Random Access Channel (PRACH).

A symbol configured to transmit an uplink channel or a signal configured by the higher layer may include a symbol indicated as being a flexible symbol by the uplink-downlink resource configuration information and configured to transmit an uplink channel or a signal configured by the higher layer.

A symbol configured to transmit an uplink channel or a signal configured by the higher layer may include a symbol indicated as being a flexible symbol or an uplink symbol by the uplink-downlink resource configuration information and configured to transmit a uplink channel or signal configured by the higher layer.

A symbol configured to receive a downlink channel or a signal configured by the higher layer may include a symbol indicated as being a flexible symbol by the uplink-downlink resource configuration information and configured to receive a downlink channel or signal configured by the higher layer.

A symbol configured to receive a downlink channel or signal configured by the higher layer may include a symbol indicated as being a flexible symbol or downlink symbol by the uplink-downlink resource configuration information and configured to receive a downlink channel or signal configured by the higher layer.

In an actual system, a part of UEs may have ability to support receiving and transmitting simultaneously on different carriers (or cells) in a time resource. For convenience of description, embodiments of the present disclosure may refer to a UE with this ability as a first type of UE. The other part of UEs can only receive at the same time, or transmit at the same time, but cannot receive and transmit simultaneously on different carriers in a time resource. Embodiments of the present disclosure may also refer to a UE with this ability as a second type of UE. For the second type of UE, it is necessary to determine to transmit or receive in a time resource according to predefined (or preset) rules.

For the second type of UE, the predefined (or preset) rules may include at least one of:
(1) If a symbol on a reference cell (e.g., cell cell_A) is indicated as being a downlink symbol by the uplink-downlink resource configuration information, such as tdd-UL-DL-ConfigurationCommon or tdd-UL-DL-ConfigurationDedicated, and the symbol on another cell (e.g., cell cell_B) is indicated as being an uplink symbol by the uplink-downlink resource configuration information, then the UE may not transmit signals on the other cell (e.g., cell cell_B).
(2) If a symbol on a reference cell (e.g., cell cell_A) is indicated as being an uplink symbol by the uplink-downlink resource configuration information, and the symbol on another cell (e.g., cell cell_B) is indicated as being a downlink symbol by the uplink-downlink resource configuration information, then the UE may not receive signals on the other cell (e.g., cell cell_B).
(3) If a symbol on a reference cell (e.g., cell cell_A) is indicated as being a downlink symbol by the uplink-downlink resource configuration information, and an uplink transmission scheduled by DCI exists in the symbol on another cell (e.g., cell cell_B), then the UE may not receive signals on the reference cell (e.g., cell cell_A).
(4) If a symbol on a reference cell (e.g., cell cell_A) is indicated as being an uplink symbol by the uplink-downlink resource configuration information, and a downlink transmission scheduled by DCI exists in the symbol on another cell (e.g., cell cell_B), then the UE may not transmit signals on the reference cell (e.g., cell cell_A).
(5) If a symbol on a reference cell (e.g., cell cell_A) is configured as a symbol for receiving a downlink channel or signal configured by the higher layer, the symbol on another cell (e.g., cell cell_B) is configured as a symbol for transmitting an uplink channel or signal configured by the higher layer, and the downlink channel or signal is not cancelled, then the UE may not transmit signals on the other cell (e.g., cell cell_B).
(6) If a symbol on a reference cell (e.g., cell cell_A) is configured as a symbol for transmitting an uplink channel or signal configured by the higher layer, the symbol on another cell (e.g., cell cell_B) is configured as a symbol for receiving a downlink channel or signal configured by the higher layer, and the uplink channel or signal is not cancelled, then the UE may not transmit signals on the other cell (e.g., cell cell_B).
(7) If a symbol on a reference cell (e.g., cell cell_A) is configured as a symbol for receiving a downlink channel or signal configured by the higher layer, the symbol on another cell (e.g., cell cell_B) is configured as a symbol for transmitting an uplink channel or signal configured by the higher layer, and the uplink channel or signal is not cancelled and the downlink channel or signal is cancelled, then the UE transmits signals on the other cell (e.g., cell cell_B).
(8) If a symbol on a reference cell (e.g., cell cell_A) is configured as a symbol for transmitting an uplink channel or signal configured by the higher layer, the symbol on another cell (e.g., cell cell_B) is configured as a symbol for receiving a downlink channel or signal configured by the higher layer, and the downlink channel or signal is not cancelled and the uplink channel or signal is cancelled, then the UE transmits signals on the other cell (e.g., cell cell_B).
(9) If a symbol on a reference cell (e.g., cell cell_A) is configured as a symbol for receiving a downlink channel or signal configured by the higher layer, the symbol on another cell (e.g., cell cell_B) is configured as a symbol for transmitting an uplink channel or signal configured by the higher layer, and a priority of the uplink transmission is not lower than a priority of the downlink transmission, then the UE may not receive signals on the reference cell (e.g., cell cell_A).
(10) If a symbol on a reference cell (e,g., cell cell_A) is configured as a symbol for transmitting an uplink channel or signal configured by the higher layer, the symbol on another cell (e.g., cell cell_B) is configured as a symbol for receiving a downlink channel or signal configured by the higher layer, and a priority of the downlink transmission is not lower than a priority of the uplink transmission, then the may not transmit signals on the reference cell (e.g., cell cell_A).
(11) If a symbol on a reference cell (e.g., cell cell_A) is configured as a symbol for receiving a downlink channel or signal configured by the higher layer, and an uplink transmission scheduled by DCI exists in the symbol on another cell (e.g., cell cell_B), then the may not receive signals on the reference cell (e.g., cell cell_A).
(12) If a symbol on a reference cell (e.g., cell cell_A) is configured as a symbol for transmitting an uplink channel or signal configured by the higher layer, and a downlink transmission scheduled by DCI exists in the symbol on another cell (e.g., cell cell_B), then the UE may not transmit signals on the reference cell (e.g., cell cell_A).
(13) If a symbol on a reference cell (e.g., cell cell_A) is configured as a symbol for receiving a downlink channel or signal configured by the higher layer, an uplink transmission scheduled by DCI exists in the symbol on another cell (e.g., cell cell_B), and a priority of the uplink transmission is not lower than a priority of the downlink transmission, then the UE may not receive signals on the reference cell (e.g., cell cell_A).
(14) If a symbol on a reference cell (e.g., cell cell_A) is configured as a symbol for transmitting an uplink channel or signal configured by the higher layer, a downlink transmission scheduled by DCI exists in the symbol on another cell (e.g., cell cell_B), and a priority of the downlink transmission is not lower than a priority of the uplink transmission, then the UE may not transmit signals on the reference cell (e.g., cell cell_A).
(15) If an uplink transmission scheduled by DCI exists in a symbol on a reference cell (e.g., cell cell_A) and a downlink transmission scheduled by DCI exists in the symbol on another cell (e.g., cell cell_B), then the UE may not receive signals on the other cell (e.g., cell cell_B).
(16) If a downlink transmission scheduled by DCI exists in a symbol on a reference cell (e.g., cell cell_A), and an uplink transmission scheduled by DCI exists in the symbol on another cell (e.g., cell cell_B), then the UE may not transmit signals on the other cell (e.g., cell cell_B).
(17) If an uplink transmission scheduled by DCI exists in a symbol on a reference cell (e.g., cell cell_A), a downlink transmission scheduled by. DCI exists in the symbol on another cell (e.g., cell cell_B), and a priority of the uplink transmission is not lower than a priority of the downlink transmission, then the UE may not receive signals on the other cell (e.g., cell cell_B).
(18) If a downlink transmission scheduled by DCI exists in a symbol on a reference cell (e.g., cell cell_A), an uplink transmission scheduled by DCI exists in the symbol on another cell (e.g., cell cell_B), and a priority of the downlink transmission is not lower than a priority of the uplink transmission, then the UE may not transmit signals on the other cell (e.g., cell cell_B).
(19) If an uplink transmission scheduled by DCI exists in a symbol on the reference cell (e.g., cell cell_A) and a downlink transmission scheduled by DCI exists in the symbol on another cell (e.g., cell cell_B), and the priority of the downlink transmission is not lower than a priority of the uplink transmission, then the UE may not send signals on the reference cell (e.g., cell cell_A).
(20) If a downlink transmission scheduled by DCI exists in a symbol on a reference cell (e.g., cell cell_A), an uplink transmission scheduled by DCI exists in the symbol on another cell (e.g., cell cell_B), and a priority of the uplink transmission is not lower than a priority of the downlink transmission, then the UE may not receive signals on the reference cell (e.g., cell cell_A).
(21) If a symbol on a reference cell (e.g., cell cell_A) is configured as a symbol for receiving a downlink channel or signal configured by the higher layer, and an uplink transmission scheduled by DCI exists in the symbol on a cell cell_B, then the UE may not receive signals on the reference cell (e.g., cell cell_A).
(22) If a symbol on a reference cell (e.g., cell cell_A) is configured as a symbol for transmitting an uplink channel or signal configured by the higher layer, and a downlink transmission scheduled by DCI and not cancelled exists in the symbol on another cell (e.g., cell cell_B), then the UE may not transmit signals on the reference cell (e.g., cell cell_A).
(23) If a uplink transmission scheduled by DCI exists in a symbol on a reference cell (e.g., cell cell_A), and a downlink transmission scheduled by DCI exists in the symbol on another cell (e.g., cell cell_B), then the UE may not receive signals on the other cell (e.g., cell cell_B).
(24) If a downlink transmission scheduled by DCI exists in a symbol on a reference cell (e.g., cell cell_A), and an uplink transmission scheduled by DCI exists in the symbol on another cell (e.g., cell cell_B), then the UE may not transmit signals on the other cell (e.g., cell cell_B).

If a first type of channel/signal exists in a symbol on the reference cell (e.g., cell cell_A), and a second type of channel/signal exists in the symbol on another cell (e.g., cell cell_B), the UE may not transmit or receive the second type of channel/signal on the other cell (e.g., cell cell_B). For example, the first type of channel/signal may include at least one of:
(1) an SS/PBCH;
(2) an SS/PBCH configured by ssb-PositionsinBurst;
(3) a PDCCH in Type-0 PDCCH common search space;
(4) a PDCCH in Type-0A PDCCH common search space;
(5) a PDCCH in Type-1 PDCCH common search space;
(6) a PDCCH in Type-2 PDCCH common search space;
(7) a PDCCH in Type-3 PDCCH common search space;
(8) a PRACH of a primary cell.

The second type of channel/signal includes channels or signals configured by the higher layer and not scheduled by DCI, except for the first type of channel/signal.

The embodiments of UE behaviors when the transmission directions of the multiple frequency-domain transmission resources (e.g., multiple carriers or multiple cells) collide are described above. In this way, when there are the multiple frequency-domain transmission resources (e.g., multiple carriers), the UE may determine whether to transmit or receive on which frequency-domain transmission resources in a symbol. Therefore, when the transmission directions of signals on the multiple frequency-domain transmission resources (e.g., multiple carriers) collide, transmission or reception of signals with a higher priority may be guaranteed, and the performance loss may be reduced.

In order to reduce the complexity of the base station or UE, the base station should avoid the case that transmission directions of some individual carriers (or cells) collide when scheduling. Accordingly, if a transmission direction of the reference cell (e.g., cell cell_A) collides with a transmission direction of other cells (e.g., cell cell_B), the UE may consider that there is an error configuration, that is, an error case occurs. That is, the UE does not expect that such error case occurs. UE behaviors corresponding to some example error cases are described below:
(1) The UE does not expect that an uplink transmission scheduled by DCI exists in a symbol on a reference cell (e.g., cell cell_A), and that a downlink transmission scheduled by DCI exists in the symbol on another cell (e.g., cell cell_B),
(2) The UE does not expect that a downlink transmission scheduled by DCI exists in a symbol on a reference cell (e.g., cell cell_A), and that an uplink transmission scheduled by DCI exists in the symbol on another cell (e.g., cell cell_B).
(3) The UE does not expect that an uplink transmission scheduled by DCI exists in a symbol on a reference cell (e.g., cell cell_A), that a downlink transmission scheduled by DCI exists in the symbol on another cell (e.g., cell cell_B), and that a priority of the uplink transmission is identical to a priority of the downlink transmission.
(4) The UE does not expect that a downlink transmission scheduled by DCI exists in a symbol on a reference cell (e.g., cell cell_A), that an uplink transmission scheduled by DCI exists in the symbol on another cell (e.g., cell cell_B), and that a priority of the uplink transmission is identical to a priority of the downlink transmission.
(5) The UE does not expect that a symbol on a reference cell (e.g., cell cell_A) is indicated as being an uplink symbol by the uplink-downlink resource configuration information, that a downlink transmission scheduled by DCI exists in the symbol on another cell (e.g., cell cell_B), and that a priority of the downlink transmission is lower than a predefined (or preset) threshold.

An example of base station configuration is provided. That is, the base station may configure, for example, two priorities, including a lower priority represented with, for example, a value of “0” and a higher priority represented with, for example, a value of “1”. If a value of the predefined (or preset) threshold is “1”, the UE does not expect that a symbol on the reference cell (e.g., cell cell_A) is indicated as being an uplink symbol by the uplink-downlink resource configuration information, that the downlink transmission scheduled by DCI exists in the symbol on the other cell (e.g., cell cell_B), and the priority of the downlink transmission is the lower priority.
(6) The UE does not expect that a symbol on a reference cell (e.g., cell cell_A) is indicated as being a downlink symbol by the uplink-downlink resource configuration information, that an uplink transmission scheduled by DCI exists in the symbol on another cell (e.g., cell cell_B), and that a priority of the uplink transmission is lower than a predefined (or preset) threshold.
(7) The UE does not expect that a symbol on a reference cell (e.g., cell cell_A) is configured as a symbol for transmitting an uplink channel or signal configured by the higher layer, that a downlink transmission scheduled by DCI exists in the symbol on another cell (e.g., cell cell_B), and that a priority of the downlink transmission is lower than a predefined (or preset) threshold.

Another example of base station configuration is provided. That is, the base station may configure, for example, two priorities, including a lower priority represented with, for example, a value “0” and a higher priority represented with, for example, a value “1”. If a value of the predefined (or preset) threshold is “1” the UE does not expect that a symbol on the reference cell (e.g., cell cell_A) is configured as a symbol for transmitting an uplink channel or signal configured by the higher layer, that the downlink transmission scheduled by DCI exists in the symbol on the other cell (e.g., cell cell_B), and that the priority of the downlink transmission is the lower priority.
(8) The UE does not expect that a symbol on a reference cell (e.g., cell cell_A) is configured as a symbol for transmitting a downlink channel or signal configured by the higher layer, that an uplink transmission scheduled by DCI exists in the symbol on another cell (e.g., cell cell_B), and that a priority of the uplink transmission is lower than a predefined (or preset) threshold.
(9) The UE does not expect that a symbol on a reference cell (e.g., cell cell_A) is configured as a symbol for transmitting an uplink channel or signal configured by the higher layer, that a downlink transmission scheduled by DCI exists in the symbol on another cell (e.g., cell cell_B), and that a priority of the downlink transmission is lower than a priority of the uplink channel or signal configured by the higher layer.
(10) The UE does not expect that a symbol on a reference cell (e.g., cell cell_A) is configured as a symbol for receiving a downlink channel or signal configured by the higher layer, that an uplink transmission scheduled by DCI exists in the symbol on another cell (e.g., cell cell_B), and that a priority of the uplink transmission is lower than a priority of the downlink channel or signal configured by the higher layer.

For a symbol, if the symbol on a cell of multiple cells in which reception and transmission cannot be performed simultaneously is indicated as being an uplink symbol or a downlink symbol by the uplink-downlink resource configuration information, or the symbol is configured as a symbol for transmitting an uplink channel or signal configured by the higher layer, or as being a symbol for receiving a downlink channel or signal configured by the higher layer, then the cell is a candidate cell among the multiple cells in which reception and transmission cannot be performed simultaneously. In this case, if the cell is a cell with a smallest cell identifier (ID) (e.g., having a smallest cell index among all candidate cells), the candidate cell is a reference cell (e,g., cell cell_A), otherwise, the candidate cell is another cell (e.g., cell cell_B).

For a symbol, if the symbol on a cell of multiple cells in which reception and transmission cannot be performed simultaneously is configured as a symbol for transmitting an uplink channel or signal configured by the higher layer, or configured as a symbol for receiving a downlink channel or signal configured by the higher layer, or a downlink transmission scheduled by DCI exists in the symbol, or an uplink transmission scheduled by DCI exists in the symbol, then the cell is a candidate cell among the multiple cells in which reception and transmission cannot be performed simultaneously. In this case, if the cell is a cell with the smallest cell ID of all candidate cells, the candidate cell is a reference cell (e.g., cell cell_A), otherwise, the candidate cell is another cell (e.g., cell cell_B).

For a specific symbol, i.e., predefined symbol, if a symbol on an uplink channel or signal configured by the higher layer that is not cancelled exists in the specific symbol on a cell of multiple cells in which reception and transmission cannot be performed simultaneously, or a symbol on a downlink channel or signal configured by the higher layer that is not cancelled exists in the specific symbol, or a downlink transmission scheduled by DCI exists in the specific symbol, or an uplink transmission scheduled by DCI exists in the specific symbol, then the cell is a candidate cell among the multiple cells in which reception and transmission cannot be performed simultaneously. In this case, if the cell is a cell with a smallest cell ID of all candidate cells, the candidate cell is a reference cell (e.g., cell cell_A), otherwise, the candidate cell is another cell (e.g., cell cell_B).

For a specific symbol, if a symbol on an uplink channel or signal configured by the higher layer that is not cancelled exists in the specific symbol on a cell of multiple cells in which reception and transmission cannot be performed simultaneously, or a symbol on a downlink channel or signal configured by the higher layer that is not cancelled exists in the specific symbol, or a downlink transmission scheduled by DCI and not cancelled exists in the specific symbol, or an uplink transmission scheduled by DCI and not cancelled exists in the specific symbol, then the cell is a candidate cell among the multiple cells in which reception and transmission cannot be performed simultaneously. In this case, if the cell is a cell with a smallest cell ID of all candidate cells, the candidate cell is a reference cell (e.g., cell cell_A), otherwise, the cell is another cell (e.g., cell cell_B).

The uplink/downlink channel or signal configured by the higher layer that is not cancelled includes at least one of:
(1) an uplink/downlink channel or signal that does not collide with the semi-statically indicated uplink-downlink resource configuration information;
(2) an uplink/downlink channel or signal that does not collide with the dynamically indicated uplink-downlink resource configuration information;
(3) an uplink/downlink channel or signal that does not collide with the dynamically indicated uplink-downlink signal transmission information;
(4) an uplink/downlink channel or signal that is not cancelled by uplink/downlink signals or reference signals with higher priority.

For example, if a priority level of an uplink/downlink channel CH_X configured by the higher layer is the lower priority (e.g., priority level “0”), a priority of another uplink/downlink channel CH_Y is the higher priority (e.g., priority level “1”), and time resources of CH_X and CH_Y at least partially overlap, then the uplink/downlink channel CH_X is cancelled.

The uplink/downlink channel or signal configured by the higher layer that is not cancelled collides with the dynamically indicated uplink-downlink resource configuration information, if at least one of the following collision cases is satisfied:
(1) the uplink channel or signal configured by the higher layer is in a semi-statically configured flexible symbol, and the UE is configured to detect a dynamic SFI, and the symbol in which the uplink channel or signal configured by the higher layer is located in a downlink symbol or a flexible symbol indicated by the dynamic SH.
(2) the downlink channel or signal configured by the higher layer is in a semi-statically configured flexible symbol, and the UE is configured to detect a dynamic SH, and the symbol in which the downlink channel or signal configured by the higher layer is located in an uplink symbol or a flexible symbol indicated by the dynamic SFI.

For example, when the base station configures PDCCHs by higher layer signaling, if a PDCCH is in the semi-statically configured flexible symbol, and the UE receives an SFI indicating that the symbol is an uplink symbol or a flexible symbol, then the PDCCH is the downlink channel configured by the higher layer that is cancelled; otherwise, the PDCCH is the downlink channel configured by the higher layer that is not cancelled.
(3) the uplink/downlink channel or signal configured by the higher layer is in a semi-statically configured flexible symbol, and the UE is configured to detect a dynamic SFI, and the UE does not detect dynamic SFI applicable to the symbol.

For example, when the base station configures cell group (CG) PUSCHs by higher layer signaling, if a CG PUSCH is in the semi-statically configured flexible symbol, and the UE receives a WI indicating that the symbol is a downlink symbol or a flexible symbol, or the UE does not detect SFI applicable to the symbol, then the CG PUCCH is the uplink channel configured by the higher layer that is cancelled; if a CG PUSCH is in a semi-statically configured flexible symbol, and the UE is not configured to detect SH, or the UE is configured to detect SFI and the received SFI indicates that the symbol is an uplink symbol, the CG PUSCH is the uplink channel configured by the higher layer that is not cancelled.
(4) the UE is configured to detect a UL cancellation indication, and the UL cancellation indication indicates to cancel the uplink channel or signal configured by the higher layer. In this case, the uplink channel or signal configured by the higher layer is the uplink channel or signal configured by the higher layer that is cancelled.

If at least one of the collision cases listed above is not satisfied, the uplink./downlink channel or signal configured by the higher layer that is not cancelled may be considered (or determined) not to collide with the dynamically indicated uplink-downlink resource configuration information.

The uplink transmission scheduled by DCI and not cancelled may include an uplink transmission that is not cancelled by uplink cancellation indication,

The uplink/downlink transmission scheduled by DCI and not cancelled may include an uplink/downlink transmission that is not cancelled by a signal with a higher priority than the priority of the uplink/downlink transmission.

If the uplink/downlink channel or signal configured by the higher layer satisfies a predefined (or preset) time line with the dynamically indicated uplink-downlink resource configuration information or the dynamically indicated uplink-downlink signal transmission information that cancels the uplink/downlink channel or signal configured by the higher layer, when determining the reference cell (e.g., cell cell_A) or determining transmission directions of signals on a cell, the uplink/downlink channel or signal configured by the higher layer is considered (or determined) to be cancelled; otherwise, the uplink/downlink channel or signal configured by the higher layer is considered (or determined) not to be cancelled.

If an uplink/downlink transmission scheduled by DCI satisfies a predefined (or preset) time line with a signal that cancels the uplink/downlink transmission, when determining the reference cell (e.g., cell cell_A) or determining transmission directions of signals on a cell, the uplink/downlink transmission scheduled by DCI is considered (or determined) to be cancelled; otherwise, the uplink/downlink transmission scheduled by DCI is considered (or determined) not to be cancelled.

If an uplink/downlink transmission scheduled by DCI satisfies a predefined (or preset) time line with a signal that cancels the uplink/downlink transmission, the uplink/downlink transmission scheduled by DCI being considered to be cancelled may include at least one of:
(1) for a symbol, if an uplink/downlink channel or signal configured by the higher layer exists in the symbol, and a time difference between a starting symbol or an ending symbol of PDCCH of the dynamically indicated uplink-downlink resource configuration information or the dynamically indicated uplink-downlink signal transmission information that cancels the uplink/downlink channel or signal configured by the higher layer and a start of the uplink downlink channel or signal configured by the higher layer is not less than a predefined (or preset) processing time, it may be considered (or determined) that the uplink/downlink channel or signal configured by the higher layer is cancelled. That is, if the time difference between the starting symbol or the ending symbol of PDCCH of the dynamically indicated uplink-downlink resource configuration information or the dynamically indicated uplink-downlink signal transmission information that cancels the uplink/downlink channel or signal configured by the higher layer and the start of the uplink/downlink channel or signal configured by the higher layer is less than the predefined (or preset) processing time, then it may he considered (or determined) that the uplink/downlink channel or signal configured by the higher layer is not cancelled.
(2) for a symbol, if an uplink/downlink channel or signal configured by the higher layer exists in the symbol, and a time difference between a starting symbol or an ending symbol of PDCCH of the dynamically indicated uplink-downlink resource configuration information or the dynamically indicated uplink-downlink signal transmission information that cancels the uplink/downlink channel or signal configured by the higher layer and a start of the symbol is not less than a predefined (or preset) processing time, then it may be considered (or determined) that the uplink/downlink channel or signal configured by the higher layer is cancelled. That is, if the time difference between the starting symbol or the ending symbol of PDCCH of the dynamically indicated uplink-downlink resource configuration information or the dynamically indicated uplink-downlink signal transmission information that cancels the uplink/downlink channel or signal configured by the higher layer and the start of the symbol is less than the predefined (or preset) processing time, then it may be considered (or determined) that the uplink/downlink channel or signal configured by the higher layer is not cancelled.
(3) for a symbol, if an uplink/downlink channel or signal SIG_X configured by the higher layer exists in the symbol on a carrier, and a channel or signal SIG_Y, a transmission direction of which collides with a transmission direction of the uplink/downlink channel or signal configured by the higher layer, exists in the symbol on another carrier, and a time difference between a starting symbol or an ending symbol of PDCCH of the dynamically indicated uplink-downlink resource configuration information or the dynamically indicated uplink-downlink signal transmission information that cancels the channel or signal SIG_X and a start of the channel or signal SIG_X is not less than a predefined (or preset) processing time, and a time difference between the starting symbol or the ending symbol of PDCCH of the dynamically indicated uplink-downlink resource configuration information or the dynamically indicated uplink-downlink signal transmission information that cancels the channel or signal SIG_X and a start of the channel or signal SIG_Y is not less than the predefined (or preset) processing time, then, when processing collision of the transmission direction of the channel or signal SIG_X and the channel or signal SIG_Y, the processing may be performed based on the channel or signal SIG_X being cancelled, otherwise, the processing may be performed based on the channel or signal SIG_X not being cancelled. That is, if the time difference between the starting symbol or the ending symbol of PDCCH of the dynamically indicated uplink-downlink resource configuration information or the dynamically indicated uplink-downlink signal transmission information that cancels the channel or signal SIG_X and the start of the channel or signal SIG_X is less than the predefined (or preset) processing time, and the time difference between the starting symbol or the ending symbol of PDCCH of the dynamically indicated uplink-downlink resource configuration information or the dynamically indicated uplink-downlink signal transmission information that cancels the channel or signal SIG_X and the start of the channel or signal SIG_Y is less than the predefined (or preset) processing time, then it may be considered (or determined) that the channel or signal SIG_X is not cancelled.
(4) for a symbol, if an uplink/downlink transmission scheduled by DCI exists in the symbol, and a time difference between a starting symbol or an ending symbol of PDCCH that cancels the uplink/downlink transmission scheduled by DCI and a start of the uplink/downlink transmission is not less than a predefined (or preset) processing time, it may be considered (or determined) that the uplink/downlink transmission scheduled by DCI is cancelled. That is, if the time difference between the starting symbol or the ending symbol of PDCCH that cancels the uplink/downlink transmission scheduled by DCI and the start of the uplink/downlink transmission is less than the predefined (or preset) processing time, then it may be considered (or determined) that the uplink/downlink transmission scheduled by DCI is not cancelled.
(5) for a symbol, if an uplink/downlink transmission scheduled by DCI exists in the symbol, and a time difference between a starting symbol or an ending symbol of PDCCH that cancels the uplink/downlink transmission scheduled by DCI and a start of the symbol is not less than a predefined (or preset) processing time, it may be considered (or determined) that the uplink/downlink transmission scheduled by DCI is cancelled. That is, if the time difference between the starting symbol or the ending symbol of PDCCH that cancels the uplink/downlink transmission scheduled by DCI and the start of the symbol is less than the predefined (or preset) processing time, it may be considered (or determined) that the uplink/downlink transmission scheduled by DCI is not cancelled.
(6) for a symbol, if an uplink/downlink transmission scheduled by DCI exists in the symbol, and a time difference between a starting symbol or an ending symbol of PDCCH that cancels the uplink/downlink transmission scheduled by DCI and a starting symbol or an ending symbol of the DCI is not less than a predefined (or preset) processing time, it may be considered (or determined) that the uplink/downlink transmission scheduled by DCI is cancelled. That is, if the time difference between the starting symbol or the ending symbol of PDCCH that cancels the uplink/downlink transmission scheduled by DCI and the starting symbol or the ending symbol of the DCI is less than the predefined (or preset) processing time, it may be considered (or determined) that the uplink/downlink transmission scheduled by DCI is not cancelled.

For a symbol, if the symbol on a cell is a part of a specific type of signal/channel, the cell is a reference cell (e.g., cell cell_A), otherwise, the cell is another cell (e.g., cell cell_B).

For example, the specific type of signal/channel may include at least one of:
(1) a signal/channel scheduled by DCI;
(2) an SS/PBCH;
(3) an SS/PBCH configured by ssb-PositionsInBurst;
(4) a PDCCH in Type-0 PDCCH common search space;
(5) a PDCCH in Type-0A PDCCH common search space;
(6) a PDCCH in Type-1 PDCCH common search space;
(7) a PDCCH in Type-2 PDCCH common search space;
(8) a PDCCH in Type-3 PDCCH common search space;
(9) a valid PRACH; and
(10) a signal/channel with a specific priority, i.e. predetermined priority. For example, the base station may configure two priorities, including a lower priority represented with, for example, a value of “0” and a higher priority represented with, for example, a value of “1”. In the example, the signal/channel with the specific priority is a signal/channel with a priority level being the higher priority (e.g., the priority is “1”).

If there is more than one cell containing the specific type of signal/channel in the same symbol, then a cell with a smallest cell ID of these cells is selected as a reference cell (e.g., cell cell_A), otherwise, the cell is another cell (e.g., cell cell_B). If the specific type of signal/channel does not exist in the same symbol, a reference cell (e.g., cell cell_A) may be determined according to one of the other ways of the embodiment.

For a symbol, if the symbol on a cell is a part of a signal/channel with a highest priority, the cell is a reference cell (e.g., cell cell_A), otherwise, the cell is another cell (e.g., cell cell_B). For example, the priority of the channel/signal may be determined according to at least one of the following ways:
(1) a signal/channel scheduled by DCI having the highest priority;
(2) an SS/PBCH having the highest priority;
(3) an SS/PBCH configured by ssb-PositionsInBurst having the highest priority;
(4) a priority of PDCCH higher than a priority of the uplink channel and/or the uplink signal configured by the higher layer;
(5) a priority of PUCCH higher than a priority of a downlink channel or signal configured by other higher layers; and
(6) a priority of valid PRACH resources higher than a priority of the downlink channel or signal configured by the higher layer.

If there is more than one cell containing signals/channels with the same highest priority in the same symbol, then a cell with a smallest cell ID of these cells is selected as a reference cell (e.g., cell cell_A). Otherwise, the cell is another cell (e.g., cell cell_B),

The base station may configure a reference cell (e.g., cell cell_A), and other cells may be another cell (e.g., cell cell_B).

A method of determining a reference cell according to an embodiment is described above. Through these example methods, the transmission of important signals is guaranteed, and the loss of uplink and/or downlink transmission caused by the collision of transmission directions in different cells is reduced.

According to an aspect of the present disclosure, in order to reduce the loss of uplink or downlink transmission caused by the collision of transmission directions on different carriers (or cells), the uplink or downlink signal that is abandoned (or cancelled) may be transmitted in the next available resource of the collision symbol according to predefined (or preset) rules.

If a PUCCH is in a symbol in which transmission directions collide, and the UE does not transmit the PUCCH, UCI information in the PUCCH which has not been transmitted is transmitted in the next available PUCCH resource after the symbol.

If at least a part of time resources of a PUSCH or PDSCH with a number K of repetitions (K is an integer greater than 0) are in a symbol in which transmission directions collide, and the UE does not transmit at least one repetition of the PUSCH or PDSCH, for example, a nominal repetition or an actual repetition, the repetition(s) of the PUSCH or PDSCH which has not been transmitted is transmitted at the start of the next available uplink symbol after the symbol. In some implementations, if at least a part of the time resources of the PUSCH or PDSCH with a number K of repetitions is in the symbol in which transmission directions collide, and the UE cannot transmit the PUSCH or PDSCH in the symbol, the symbol is an invalid symbol. In this case, a nominal repetition may be made to avoid the invalid symbol, and the nominal repetition may be divided into one or more actual repetitions.

If at least a part of time resources of a PUSCH or PDSCH mapped into Q time resource units (Q is an integer greater than 0) is in a symbol in which transmission directions collide, and the UE does not transmit the PUSCH or PDSCH in at least one time resource unit of the Q time resources, the PUSCH or PDSCH in the time resources which has not been transmitted is transmitted at the start of the next available uplink symbol after the symbol.

According to an aspect of the present disclosure, in order to reduce the loss of uplink and/or downlink transmission caused by the collision of transmission directions on different carriers, an available carrier may be determined according to predefined (or preset) rules, and in resources of the determined available carrier, uplink signals may be transmitted or downlink signals may he received.

The base station may configure at least two uplink carriers for transmission of a PRACH. The UE may select a carrier of the at least two uplink carriers to transmit the PRACH according to predefined (or preset) rules.

In an example, the base station configures two uplink carriers for the UE for a beam failure reconstruction process, for example, configuring PRACH-ResourceDedicatedBFR on the two uplink carriers for the UE. The UE preferentially transmits a PRACH on a first uplink carrier; for example, the first uplink carrier is a primary cell or a primary secondary cell, and the UE may transmit the PRACH on a second uplink carrier only when the first uplink carrier is not available. The UE may determine whether the first uplink carrier may be used for uplink transmission at a time according to the method described in the embodiments. The UE may also determine whether the first uplink carrier may be used for uplink transmission at a time according to other technologies. Alternatively, the base station may configure available time resource information of respective uplink carriers, and the UE may find an available uplink carrier according to the time resource information and transmit PRACH. As another alternative, the base station may indicate available uplink carrier information by physical layer signaling. As a further alternative, the UE transmits PRACH on a reference cell.

The processing method when transmission directions on different frequency-domain transmission resources (e.g., carriers) collide according to an embodiment is described above. The method described above is applicable to multiple carriers in the same frequency, e.g., intra-band CA. In some implementations, the method described above is applicable to carriers located in different bands, e.g., inter-band CA. The method described above is also applicable to multiple frequency-domain transmission resource units located in the same carrier, for example, a frequency-domain transmission resource unit is a BWP or RB set. In this case, the carrier in the method described above may be replaced with a BWP or an RB set. “″” For the sake of brevity, the corresponding description will be omitted.

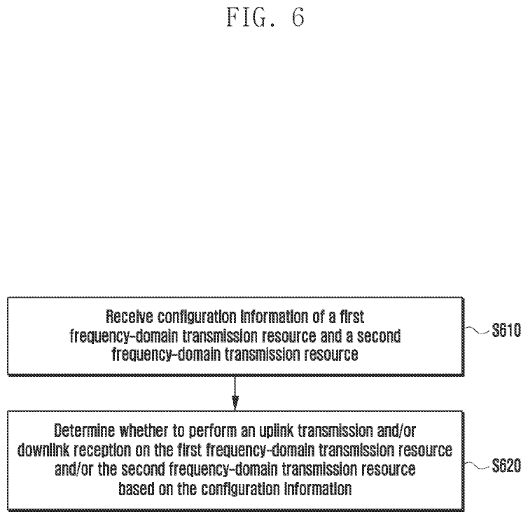

FIG. 6 illustrates a flowchart of a method performed by a terminal according to an embodiment.

Referring to FIG. 6, in step S610, the terminal may receive configuration information of a first frequency-domain transmission resource and a second frequency-domain transmission resource. The first frequency-domain transmission resource and the second frequency-domain transmission resource partially overlap or completely overlap in time domain. Examples for the configuration information of the frequency-domain transmission resources may refer to various embodiments described above in connection with FIG. 5.

Next, in step S620, the terminal may determine whether to perform an uplink transmission and/or downlink reception on the first frequency-domain transmission resource and/or the second frequency-domain transmission resource based on the configuration information.

Determining whether to perform an uplink transmission and/or downlink reception on the first frequency-domain transmission resource and/or the second frequency-domain transmission resource based on the configuration information may include determining whether to perform the uplink transmission and/or the downlink reception on the first frequency-domain transmission resource and/or the second frequency-domain transmission resource based on the configuration information, when the configuration information indicates that transmission directions of the first frequency-domain transmission resource and the second frequency-domain transmission resource are different.

Determining whether to perform an uplink transmission and/or downlink reception on the first frequency-domain transmission resource and/or the second frequency-domain transmission resource based on the configuration information may also include determining whether to perform the uplink transmission and/or the downlink reception on the first frequency-domain transmission resource and/or the second frequency-domain transmission resource according to at least one of the configuration information, priority information, control information, a type of a signal to be transmitted, or a type of a signal to be received.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information may include at least one of, the terminal not performing the uplink transmission on the second frequency-domain transmission resource, when a symbol on the first frequency-domain transmission resource is indicated as being a downlink symbol by the configuration information and the symbol on the second frequency-domain transmission resource is indicated as being an uplink symbol by the configuration information; the terminal not performing the uplink transmission on the first frequency-domain transmission resource, when a symbol on the first frequency-domain transmission resource is indicated as being an uplink symbol by the configuration information and the symbol on the second frequency-domain transmission resource is indicated as being a downlink symbol by the configuration information; the terminal not performing the downlink reception on the first frequency-domain transmission resource, when a symbol on the first frequency-domain transmission resource is indicated as being a downlink symbol by the configuration information and an uplink transmission scheduled by downlink control information DCI exists in the symbol on the second frequency-domain transmission resource; or the terminal not performing the uplink transmission on the first frequency-domain transmission resource, when a symbol on the first frequency-domain transmission resource is indicated as being an uplink symbol by the configuration information and a downlink reception scheduled by DCI exists in the symbol on the second frequency-domain transmission resource.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information includes, when a symbol on the first frequency-domain transmission resource is configured for first transmission and the symbol on the second frequency-domain transmission resource is configured for second transmission: the terminal does not perform the second transmission on the second frequency-domain transmission resource, if the first transmission is not cancelled; and/or the terminal performs the second transmission on the second frequency-domain transmission resource, if the second transmission is not cancelled and the first transmission is cancelled; and/or the terminal does not perform the first transmission on the first frequency-domain transmission resource, if a priority of the second transmission is not lower than a priority of the first transmission. The first transmission is used to receive a downlink channel and/or a downlink signal configured by a higher layer, and the second transmission is used to transmit the downlink channel and/or the downlink signal configured by the higher layer. Alternatively, the first transmission is used to transmit a downlink channel and/or a downlink signal configured by a higher layer, and the second transmission is used to receive the downlink channel and/or the downlink signal configured by the higher layer.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information includes, when a symbol on the first frequency-domain transmission resource is configured to receive a downlink channel and/or a downlink signal configured by a higher layer, and an uplink transmission scheduled by DCI exists in the symbol on the second frequency-domain transmission resource: the terminal does not receive the downlink channel and/or the downlink signal configured by the higher layer on the first frequency-domain transmission resource; and/or the terminal does not receive the downlink channel and/or the downlink signal configured by the higher layer on the first frequency-domain transmission resource, if a priority of the uplink transmission scheduled by the DCI is not lower than a priority of reception of the downlink channel and/or the downlink signal configured by the higher layer; and/or the terminal does not receive the downlink channel and/or the downlink signal configured by the higher layer on the first frequency-domain transmission resource, if the uplink transmission is not cancelled.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information includes, when a symbol on the first frequency-domain transmission resource is configured to transmit an uplink channel and/or an uplink signal configured by a higher layer, and a downlink reception scheduled by DCI exists in the symbol on the second frequency-domain transmission resource: the terminal does not transmit the uplink channel and/or the uplink signal configured by the higher layer on the first frequency-domain transmission resource; and/or the terminal does not transmit the uplink channel and/or the uplink signal configured by the higher layer on the first frequency-domain transmission resource, if a priority of the downlink reception scheduled by the DCI is not lower than a priority of transmission of the uplink channel and/or the uplink signal configured by the higher layer; and/or the terminal does not transmit the uplink channel and/or the uplink signal configured by the higher layer on the first frequency-domain transmission resource, if the downlink reception is not cancelled.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information includes, when uplink transmission scheduled by DCI exists in a symbol on the first frequency-domain transmission resource, and a downlink reception scheduled by DCI exists in the symbol on the second frequency-domain transmission resource: the terminal does not perform the downlink reception on the second frequency-domain transmission resource; and/or the terminal does not perform the downlink reception on the second frequency-domain transmission resource, if a priority of the uplink transmission is not lower than a priority of the downlink reception; and/or the terminal does not perform the uplink transmission on the first frequency-domain transmission resource, if a priority of the downlink reception is not lower than a priority of the uplink transmission; and/or the terminal does not perform the downlink reception on the second frequency-domain transmission resource, if the uplink transmission is not cancelled.

When the first frequency-domain transmission resource is a reference frequency-domain transmission resource, determining whether to perform an uplink transmission and/or downlink reception on the first frequency-domain transmission resource and/or the second frequency-domain transmission resource based on the configuration information includes, when downlink reception scheduled by DCI exists in a symbol on the first frequency-domain transmission resource, and an uplink transmission scheduled by DCI exists in the symbol on the second frequency-domain transmission resource: the terminal does not perform the uplink transmission on the second frequency-domain transmission resource; and/or the terminal does not perform the uplink transmission on the second frequency-domain transmission resource, if a priority of the downlink reception is not lower than a priority of the uplink transmission; and/or the terminal does not perform the downlink reception on the first frequency-domain transmission resource, if a priority of the uplink transmission is not lower than a priority of the downlink reception; and/or the terminal does not perform the uplink transmission on the second frequency-domain transmission resource, if the downlink reception is not cancelled.

When the first frequency-domain transmission resource is a reference frequency-domain transmission resource, the terminal does not expect that an uplink transmission scheduled by DCI exists in a symbol on the first frequency-domain transmission resource, and that a downlink reception scheduled by DCI exists in the symbol on the second frequency-domain transmission resource; and/or the terminal does not expect that a downlink reception scheduled by DCI exists in a symbol on the first frequency-domain transmission resource, and that an uplink transmission scheduled by DCI exists in the symbol on the second frequency-domain transmission resource; and/or the terminal does not expect that an uplink transmission scheduled by DCI exists in a symbol on the first frequency-domain transmission resource, that a downlink reception scheduled by DCI exists in the symbol on the second frequency-domain transmission resource, and that a priority of the uplink transmission is the same as a priority of the downlink reception; and/or the terminal does not expect that a downlink reception scheduled by DCI exists in a symbol on the first frequency-domain transmission resource, that an uplink transmission scheduled by DCI exists in the symbol on the second frequency-domain transmission resource, and a priority of the downlink reception is the same as a priority of the uplink transmission; and/or the terminal does not expect that a symbol on the first frequency-domain transmission resource is indicated as being an uplink symbol by the configuration information, that a downlink reception scheduled by DCI exists in the symbol on the second frequency-domain transmission resource, and that a priority of the downlink reception is lower than a predefined threshold; and/or the terminal does not expect that a symbol on the first frequency-domain transmission resource is indicated as being a downlink symbol by the configuration information, that an uplink transmission scheduled by DCI exists in the symbol on the second frequency-domain transmission resource, and that a priority of the uplink transmission is lower than a predefined threshold; and/or the terminal does not expect that a symbol on the first frequency-domain transmission resource is configured to transmit an uplink channel and/or an uplink signal configured by a higher layer, that a downlink reception scheduled by DCI exists in the symbol on the second frequency-domain transmission resource, and a priority of the downlink reception is lower than a predefined threshold; and/or the terminal does not expect that a symbol on the first frequency-domain transmission resource is configured to receive a downlink channel and/or a downlink signal configured by a higher layer, and an uplink transmission scheduled by DCI exists in the symbol on the second frequency-domain transmission resource, and a priority of the uplink transmission is lower than a predefined threshold; and/or the terminal does not expect that a symbol on the first frequency-domain transmission resource is configured to transmit an uplink channel and/or an uplink signal configured by a higher layer, that a downlink reception scheduled by DCI exists in the symbol on the second frequency-domain transmission resource, and that a priority of the downlink reception is lower than a priority of the uplink channel and/or the uplink signal configured by the higher layer; and/or the terminal does not expect that a symbol on the first frequency-domain transmission resource is configured to transmit a downlink channel and/or a downlink signal configured by a higher layer, that an uplink transmission scheduled by DCI exists in the symbol on the second frequency-domain transmission resource, and a priority of the uplink transmission is lower than a priority of the downlink channel and/or the downlink signal configured by the higher layer.

A candidate frequency-domain transmission resource with a smallest frequency-domain transmission resource identification (ID) of at least one candidate frequency-domain transmission resource among multiple frequency-domain transmission resources in which reception and transmission cannot be performed simultaneously is determined as the reference frequency-domain transmission resource, where the at least one candidate frequency-domain transmission resource includes at least one of: a frequency-domain transmission resource on which a symbol is indicated as being an uplink symbol or a downlink symbol by the configuration information; and/or a frequency-domain transmission resource, on which a symbol is configured as a symbol for transmitting an uplink channel and/or an uplink signal configured by a higher layer; and/or a frequency-domain transmission resource on which a symbol is configured as a symbol for receiving a downlink channel and/or a downlink signal configured by a higher layer; and/or a frequency-domain transmission resource on which a downlink reception scheduled by DCI existing in a symbol; and/or a frequency-domain transmission resource on which uplink transmission scheduled by DCI existing in a symbol; and/or a frequency-domain transmission resource on which an uplink channel and/or an uplink signal configured by a higher layer that is not cancelled existing in a symbol; and/or a frequency-domain transmission resource on which a downlink channel and/or a downlink signal configured by a higher layer that is not cancelled existing in a symbol; and/or a frequency-domain transmission resource on which a downlink reception scheduled by DCI and not cancelled existing in a symbol; and/or a frequency-domain transmission resource on which an uplink transmission scheduled by DCI and not cancelled existing in a symbol. An example for determining the reference frequency-domain transmission resources is described below For example, the terminal first determines at least one candidate frequency-domain transmission resource (e.g., candidate cell) among multiple frequency-domain transmission resources (e.g., multiple carriers) in which reception and transmission cannot be performed simultaneously. Then, the terminal may select a candidate frequency-domain transmission resource with a smallest frequency-domain transmission ID from the at least one candidate frequency-domain. transmission resource (e.g., candidate cell) as the reference frequency-domain transmission resource.

The uplink channel and/or the uplink signal configured by the higher layer that is not cancelled include at least one of an uplink channel or an uplink signal that does not collide with the configuration information, or an uplink channel or an uplink signal that is not cancelled by an uplink channel and/or an uplink signal with a higher priority.

The downlink channel and/or the downlink signal configured by the higher layer that is not cancelled includes at least one of a downlink channel or a downlink signal that does not collide with the configuration information, or a downlink channel or a downlink signal that is not cancelled by a downlink channel and/or a downlink signal with a higher priority.

The configuration information includes dynamically indicated uplink-downlink resource configuration information including at least one of a dynamic SFI or an uplink cancellation indication, and if at least one of the following conditions is satisfied, the uplink channel and/or the uplink signal configured by the higher layer that is not cancelled is determined to collide with the dynamically indicated uplink-downlink resource configuration information: the uplink channel and/or the uplink signal configured by the higher layer is in a semi-statically configured flexible symbol, and a symbol in which the uplink channel and/or the uplink signal configured by the higher layer is located in a downlink symbol or a flexible symbol indicated by the dynamic SFI; the downlink channel and/or the downlink signal configured by the higher layer is in a semi-statically configured flexible symbol, and a symbol in which the downlink channel and/or the downlink signal configured by the higher layer is located in an uplink symbol or a flexible symbol indicated by the dynamic SFI; the uplink channel and/or the uplink signal configured by the higher layer is in a semi-statically configured flexible symbol, and the terminal does not detect a dynamic SFI applicable to the flexible symbol; or the uplink cancellation indication indicates to cancel the uplink channel and/or the uplink signal configured by the higher layer.

The uplink transmission scheduled by the DCI and not cancelled includes an uplink transmission that is not cancelled by the uplink cancellation indication.

The uplink transmission scheduled by the DCI and not cancelled includes an uplink transmission that is not cancelled by a signal with a higher priority than the priority of the uplink transmission.

The downlink reception scheduled by the DCI and not cancelled includes a downlink reception that is not cancelled by a signal with a higher priority than the priority of the downlink reception.

The uplink transmission scheduled by the DCI and not cancelled includes an uplink transmission that satisfies a predefined time requirement with a signal for cancelling the uplink transmission.

The downlink reception scheduled by the DCI and not cancelled includes a downlink reception that satisfies a predefined time requirement with a signal for cancelling the downlink reception.

The uplink channel and/or the uplink signal configured by the higher layer that is not cancelled includes an uplink channel and/or an uplink signal configured by the higher layer that satisfies a predefined time requirement with the configuration information cancelling the uplink channel and/or the uplink signal configured by the higher layer.

The downlink channel and/or the downlink signal configured by the higher layer that is not cancelled includes a downlink channel and/or a downlink signal configured by the higher layer that satisfies a predefined time requirement with the configuration information cancelling the downlink channel and/or the downlink signal configured by the higher layer.

The reference frequency-domain transmission resource includes frequency-domain transmission resource whose symbol is at least a part of a specific type of signal/channel.

The specific type of signal/channel includes at least one of: at least one of a signal or a channel scheduled by DCI, a synchronization signal/physical broadcast channel, a PDCCH in a common search space, or at least one of a signal or a channel with a specific priority, i.e., predetermined priority.

If the symbol of the first frequency-domain transmission resource is at least a part of a signal with a highest priority or at least a part of a channel with a highest priority, the first frequency-domain transmission resource is determined as the reference frequency-domain transmission resource.

Each of the first frequency-domain transmission resource and the second frequency-domain transmission resource includes at least one of a carrier, a carrier group, a bandwidth part, or a resource block set.

The method further comprises transmitting PRACH through a carrier of a primary cell or a primary secondary cell when the carrier of the primary cell or the primary secondary cell is available; otherwise, transmitting the PRACH through a carrier of a secondary cell.

A method performed by the terminal according to the embodiment of the present disclosure is described above. This method provides a solution to the collision problem between transmission directions on different frequency-domain transmission resources. For example, the method can at least guarantee the transmission of more important signals and reduce the loss of uplink and/or downlink transmission caused by the collision of transmission directions on different frequency-domain transmission resources (e.g., carriers).

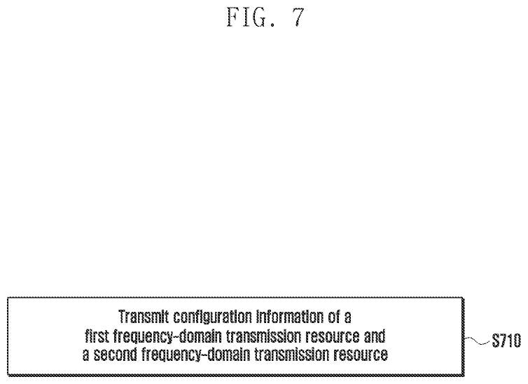

FIG. 7 illustrates a method performed by a base station according to an embodiment.

Referring to FIG. 7, in step S710, the base station may transmit configuration information of a first frequency-domain transmission resource and a second frequency-domain transmission resource to a terminal, The first frequency-domain transmission resource and the second frequency-domain transmission resource partially overlap or completely overlap in time domain.

Based on the configuration information, the terminal may determine whether to perform an uplink transmission and/or downlink reception on the first frequency-domain transmission resource and/or the second frequency-domain transmission resource based on the configuration information. The method for the terminal to determine whether to perform an uplink transmission and/or downlink reception on the first frequency-domain transmission resource and/or the second frequency-domain transmission resource may refer to various embodiments described previously.

The method may further include that the base station determines whether to perform an uplink reception on the first frequency-domain transmission resource and/or the second frequency-domain transmission resource based on the configuration information.

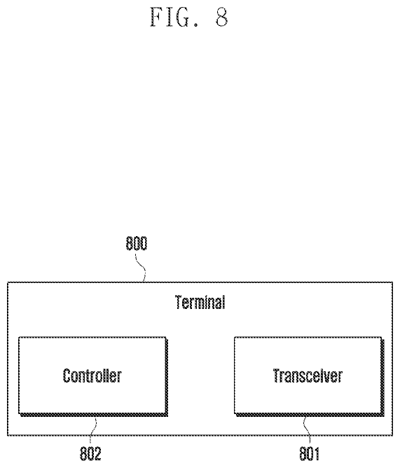

FIG. 8 is a block diagram of a configuration of a terminal 800 according to an embodiment.

Referring to FIG. 8, the terminal 800 may include a transceiver 801 and a controller 802. For example, the controller 802 may be coupled to the transceiver 801 For example, the transceiver 801 may be configured to transmit and receive signals. For example, the controller 802 may be configured to perform one or more operations in the method according to various embodiments described above.

Although the terminal is illustrated as having separate functional blocks for convenience of explanation, the configuration of the terminal 800 is not limited thereto. example, the terminal 800 may include a communication unit composed of a transceiver and a processor. The terminal 800 may communicate with at least one network node by means of the communication unit.

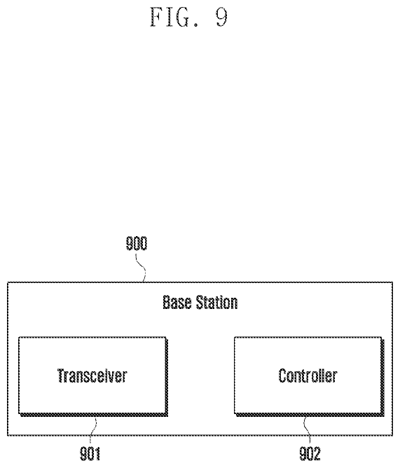

FIG. 9 is a block diagram of a base station 900 according to an embodiment.

Referring to FIG. 9, the base station 900 may include a transceiver 901 and a controller 902. For example, the controller 902 may be coupled to the transceiver 901. For example, the transceiver 901 may be configured to transmit and receive signals. The controller 902 may be configured to perform one or more operations in the method according to various embodiments described above.

Although the base station 900 is illustrated as having separate functional blocks for convenience of explanation, the configuration of the base station is not limited thereto. For example, the base station 900 may include a communication unit composed of a transceiver and a processor. The base station 900 may communicate with at least one network node by means of the communication unit.

According to the embodiments of the present disclosure, at least part of the apparatus (e.g., modules or functions thereof) or the method (e.g., operations) may be implemented by an instruction which is stored in a computer-readable storage medium the memory) in a form of a program module. When executed by a processor or controller, the instruction may enable the processor or controller to perform corresponding functions. The computer-readable medium may include, for example, a hard disk, a floppy disk, a magnetic media, an optical recording media, a DVD, a magneto-optical media, and the like. The instructions may include a code made by a compiler or a code which can be executed by an interpreter. The module or apparatus may include at least one or more of the aforementioned elements, some of the aforementioned elements may be omitted, or may further include other additional elements. Operations executed by the module, program module, or other elements may be executed sequentially, in parallel, repeatedly, or in a heuristic way. Alternatively, at least some operations may be executed in a different order or may be omitted, or other operations may be added.

What has been described above are only example embodiments of the present disclosure, and are not intended to limit the scope of protection of the present disclosure, which is determined by the appended claims.

What is claimed is:

1. A method performed by a terminal, comprising:
receiving configuration information of a first frequency-domain transmission resource and a second frequency-domain transmission resource, wherein the first frequency-domain transmission resource and the second frequency-domain transmission resource partially overlap or completely overlap in a time domain; and
determining whether to perform at least one of an uplink transmission or a downlink reception on the first frequency-domain transmission resource or the second frequency-domain transmission resource based on the configuration information.

2. The method of claim 1,
wherein whether to perform the at least one of the uplink transmission or the downlink reception on the first frequency-domain transmission resource or the second frequency-domain transmission resource is determined based on the configuration information indicating that transmission directions of the first frequency-domain transmission resource and the second frequency-domain transmission resource are different.

3. The method of claim 1,
wherein determining whether to perform the at least one of the uplink transmission or the downlink reception on the first frequency-domain transmission resource or the second frequency-domain transmission resource is based on at least one of: the configuration information, priority information, control information, a type of a signal to be transmitted, or a type of a signal to be received.

4. The method of claim 1, wherein, when the first frequency-domain transmission resource is a reference frequency-domain transmission resource, determining whether to perform the at least one of the uplink transmission or the downlink reception comprises at least one of:
not performing, by the terminal, the uplink transmission on the second frequency-domain transmission resource, when a symbol on the first frequency-domain transmission resource is indicated as being a downlink symbol by the configuration information and the symbol on the second frequency-domain transmission resource is indicated as being an uplink symbol by the configuration information;
not performing, by the terminal, the uplink transmission on the first frequency-domain transmission resource, when a symbol on the first frequency domain transmission resource is indicated as being an uplink symbol by the configuration information and the symbol on the second frequency-domain transmission resource is indicated as being a downlink symbol by the configuration information;
not performing, by the terminal, the downlink reception on the first frequency-domain transmission resource, when a symbol on the first frequency-domain transmission resource is indicated as being a downlink symbol by the configuration information and an uplink transmission scheduled by downlink control information (DCI) exists in the symbol on the second frequency-domain transmission resource; or
not performing, by the terminal, the uplink transmission on the first frequency-domain transmission resource, when a symbol on the first frequency-domain transmission resource is indicated as being an uplink symbol by the configuration information and a downlink reception scheduled by DCI exists in the symbol on the second frequency-domain transmission resource.

5. The method of claim 1, wherein, when the first frequency-domain transmission resource is a reference frequency-domain transmission resource,
when a symbol on the first frequency-domain transmission resource is configured for first transmission and the symbol on the second frequency-domain transmission resource is configured for second transmission, determining whether to perform the at least one of the uplink transmission or the downlink reception comprises at least one of:
the terminal does not perform the second transmission on the second frequency-domain transmission resource, in case that the first transmission is not cancelled,
the terminal performs the second transmission on the second frequency-domain transmission resource, in case that the second transmission is not cancelled and the first transmission is cancelled, or
the terminal does not perform the first transmission on the first frequency-domain transmission resource, in case that a priority of the second transmission is not lower than a priority of the first transmission, and
wherein the first transmission is used to receive at least one of a downlink channel or a downlink signal configured by a higher layer, and the second transmission is used to transmit the at least one of the downlink. channel or the downlink signal configured by the higher layer; or the first transmission is used to transmit at least one of a downlink channel or a downlink signal configured by the higher layer, and the second transmission is used to receive the at least one of the downlink channel or the downlink signal configured by the higher layer.

6. The method of claim 1, wherein, when the first frequency-domain transmission resource is a reference frequency-domain transmission resource, and
when a symbol on the first frequency-domain transmission resource is configured to receive at least one of a downlink channel or a downlink signal configured by a higher layer, and an uplink transmission scheduled by DCI exists in the symbol on the second frequency-domain transmission resource, determining whether to perform the at least one of the uplink transmission or the downlink reception comprises at least one of:
the terminal does not receive the at least one of the downlink channel or the downlink signal configured by the higher layer on the first frequency-domain transmission resource,
the terminal does not receive the at least one of the downlink channel or the downlink signal configured by the higher layer on the first frequency-domain transmission resource, in case that a priority of the uplink transmission scheduled by the DCI is not lower than a priority of reception of the at least one of the downlink channel or the downlink signal configured by the higher layer, or
the terminal does not receive the at least one of the downlink channel or the downlink signal configured by the higher layer on the first frequency-domain transmission resource, in case that the uplink transmission is not cancelled.

7. The method of claim 1, wherein, when the first frequency-domain transmission resource is a reference frequency-domain transmission resource, and
when a symbol on the first frequency-domain transmission resource is configured to transmit at least one of an uplink channel or an uplink signal configured by a higher layer, and a downlink reception scheduled by downlink control information (DCI) exists in the symbol on the second frequency-domain transmission resource, determining whether to perform the at least one of the uplink transmission or the downlink reception comprises at least one of:
the terminal does not transmit the at least one of the uplink channel or the uplink signal configured by the higher layer on the first frequency-domain transmission resource,
the terminal does not transmit the at least one of the uplink channel or the uplink signal configured by the higher layer on the first frequency-domain transmission resource, in case that a priority of the downlink reception scheduled by the DCI is not lower than a priority of transmission of the at least one of the uplink channel or the uplink signal configured by the higher layer, or
the terminal does not transmit the at least one of the uplink channel or the uplink signal configured by the higher layer on the first frequency-domain transmission resource, in case that the downlink reception is not cancelled.

8. The method of claim 1, wherein, when the first frequency-domain transmission resource is a reference frequency-domain transmission resource, and
when uplink transmission scheduled by downlink control information (DCI) exists in a symbol on the first frequency-domain transmission resource, and a downlink reception scheduled by DCI exists in the symbol on the second frequency-domain transmission resource, determining whether to perform the at least one of the uplink transmission or downlink reception comprises at least one of:
not performing, by the terminal, the downlink reception on the second frequency-domain transmission resource,
not performing, by the terminal, the downlink reception on the second frequency-domain transmission resource, in case that a priority of the uplink transmission is not lower than a priority of the downlink reception,
not performing, by the terminal, the uplink transmission on the first frequency-domain transmission resource, in case that a priority of the downlink reception is not lower than a priority of the uplink transmission, or
not performing, by the terminal, the downlink reception on the second frequency-domain transmission resource, in case that the uplink transmission is not cancelled.

9. The method of claim 1, wherein, when the first frequency-domain transmission resource is a reference frequency-domain transmission resource, and
when downlink reception scheduled by downlink control information (DCI) exists in a symbol on the first frequency-domain transmission resource, and an uplink transmission scheduled by DCI exists in the symbol on the second frequency-domain transmission resource, determining whether to perform the at least one of the uplink transmission or the downlink reception comprises at least one of:
not performing, by the terminal, the uplink transmission on the second frequency-domain transmission resource,
not performing, by the terminal, the uplink transmission on the second frequency-domain transmission resource, in case that a priority of the downlink reception is not lower than a priority of the uplink transmission,
not performing, by the terminal, the downlink reception on the first frequency-domain transmission resource, in case that a priority of the uplink transmission is not lower than a priority of the downlink reception, or
not performing, by the terminal, the uplink transmission on the second frequency-domain transmission resource, in case that the downlink reception is not cancelled.

10. The method of claim 1, wherein, when the first frequency-domain transmission resource is a reference frequency-domain transmission resource:
the terminal does not expect that an uplink transmission scheduled by downlink control information (DCI) exists in a symbol on the first frequency-domain transmission resource, and that a downlink reception scheduled by DCI exists in the symbol on the second frequency-domain transmission resource;
the terminal does not expect that a downlink reception scheduled by DCI exists in a symbol on the first frequency-domain transmission resource, and that an uplink transmission scheduled by DCI exists in the symbol on the second frequency-domain transmission resource;
the terminal does not expect that an uplink transmission scheduled by DCI exists in a symbol on the first frequency-domain transmission resource, that a downlink reception scheduled by DCI exists in the symbol on the second frequency-domain transmission resource, and that a priority of the uplink transmission is identical to a priority of the downlink reception;
the terminal does not expect that a downlink reception scheduled by DCI exists in a symbol on the first frequency-domain transmission resource, that an uplink transmission scheduled by DCI exists in the symbol on the second frequency-domain transmission resource, and a priority of the downlink reception is identical to a priority of the uplink transmission;
the terminal does not expect that a symbol on the first frequency-domain transmission resource is indicated as being an uplink symbol by the configuration information, that a downlink reception scheduled by DCI exists in the symbol on the second frequency-domain transmission resource, and that a priority of the downlink reception is lower than a predefined threshold;
the terminal does not expect that a symbol on the first frequency-domain transmission resource is indicated as being a downlink symbol by the configuration information, that an uplink transmission scheduled by DCI exists in the symbol on the second frequency-domain transmission resource, and that a priority of the uplink transmission is lower than a predefined threshold;
the terminal does not expect that a symbol on the first frequency-domain transmission resource is configured to transmit at least one of an uplink channel or an uplink signal configured by a higher layer, that a downlink reception scheduled by DCI exists in the symbol on the second frequency-domain transmission resource, and a priority of the downlink reception is lower than a predefined threshold;
the terminal does not expect that a symbol on the first frequency-domain transmission resource is configured to receive at least one of a downlink channel or a downlink signal configured by the higher layer, and an uplink transmission scheduled by DCI exists in the symbol on the second frequency-domain transmission resource, and a priority of the uplink transmission is lower than a predefined threshold;
the terminal does not expect that a symbol on the first frequency-domain transmission resource is configured to transmit at least one of an uplink channel or an uplink signal configured by the higher layer, that a downlink reception scheduled by DCI exists in the symbol on the second frequency-domain transmission resource, and that a priority of the downlink reception is lower than a priority of the at least one of the uplink channel or the uplink signal configured by the higher layer; or
the terminal does not expect that a symbol on the first frequency-domain transmission resource is configured to transmit at least one of a downlink channel or a downlink signal configured by the higher layer, that an uplink transmission scheduled by DCI exists in the symbol on the second frequency-domain transmission resource, and a priority of the uplink transmission is lower than a priority of the downlink channel and/or the downlink signal configured by the higher layer.

11. The method of claim 4, wherein a candidate frequency-domain transmission resource with a smallest frequency-domain transmission resource identification of at least one candidate frequency-domain transmission resource among multiple frequency-domain transmission resources in which reception and transmission cannot be performed simultaneously, is determined as the reference frequency-domain transmission resource, and
wherein the at least one candidate frequency-domain transmission resource includes at least one of:
a frequency-domain transmission resource on which a symbol is indicated as being an uplink symbol or a downlink symbol by the configuration information;
a frequency-domain transmission resource on which a symbol is configured as a symbol for transmitting at least one of an uplink channel or an uplink signal configured by a higher layer;
a frequency-domain transmission resource on which a symbol is configured as a symbol for receiving at least one of a downlink channel or a downlink signal configured by the higher layer;
a frequency-domain transmission resource on which a downlink reception scheduled by DCI exists in a symbol;
a frequency-domain transmission resource on which an uplink transmission scheduled by DCI exists in a symbol;
a frequency-domain transmission resource on which at least one of an uplink channel or an uplink signal configured by the higher layer that is not cancelled exists in a symbol;
a frequency-domain transmission resource on which at least one of a downlink channel or a downlink signal configured by the higher layer that is not cancelled exists in a symbol;
a frequency-domain transmission resource on which a downlink reception scheduled by DCI and not cancelled exists in a symbol; or
a frequency-domain transmission resource on which an uplink transmission scheduled by DCI and not cancelled exists in a symbol.

12. The method of claim 11,
wherein the at least one of the uplink channel or the uplink signal configured by the higher layer that is not cancelled include at least one of:
at least one of an uplink channel or an uplink signal that does not collide with the configuration information, or
at least one of an uplink channel or an uplink signal that is not cancelled by at least one of an uplink channel or an uplink signal with a higher priority, or
wherein the at least one of the downlink channel or the downlink signal configured by the higher layer that is not cancelled includes at least one of:
at least one of a downlink channel or a downlink signal that does not collide with the configuration information, or
at least one of the a downlink channel or a downlink signal that is not cancelled by at least one of a downlink channel or a downlink signal with a higher priority.

13. The method of claim 12, wherein the configuration information includes dynamically indicated uplink-downlink resource configuration information including at least one of a dynamic slot format indicator (SFI) or an uplink cancellation indication, and
wherein in case that at least one of conditions is satisfied, the at least one of the uplink channel or the uplink signal configured by the higher layer that is not cancelled is determined to collide with the dynamically indicated uplink-downlink resource configuration information,
wherein the conditions comprise:
the at least one of the uplink channel or the uplink signal configured by the higher layer is in a semi-statically configured flexible symbol, and a symbol in which the at least one of the uplink channel or the uplink signal configured by the higher layer is located in a downlink symbol or a flexible symbol indicated by the dynamic SFI;
the at least one of the downlink channel or the downlink signal configured by the higher layer is in a semi-statically configured flexible symbol, and a symbol in which the downlink channel and/or the downlink signal configured by the higher layer is located in an uplink symbol or a flexible symbol indicated by the dynamic SFI;
the at least one of the uplink channel or the uplink signal configured by the higher layer is in a semi-statically configured flexible symbol, and the terminal does not detect a dynamic SFI applicable to the flexible symbol; and
the uplink cancellation indication indicates to cancel the at least one of the uplink channel or the uplink signal configured by the higher layer.

14. The method of claim 11, wherein:
the uplink transmission scheduled by the DCI and not cancelled includes an uplink transmission that is not cancelled by the uplink cancellation indication;
the uplink transmission scheduled by the DCI and not cancelled includes an uplink transmission that is not cancelled by a signal with a higher priority than the uplink transmission;
the downlink reception scheduled by the DCI and not cancelled includes a downlink reception that is not cancelled by a signal with a higher priority than the downlink reception;
the uplink transmission scheduled by the DCI and not cancelled includes an uplink transmission that satisfies a predefined time requirement with a signal for cancelling the uplink transmission;
the downlink reception scheduled by the DCI and not cancelled includes a downlink reception that satisfies a predefined time requirement with a signal for cancelling the downlink reception;
the uplink channel and/or the uplink signal configured by the higher layer that is not cancelled includes at least one of an uplink channel or an uplink signal configured by the higher layer that satisfies a predefined time requirement with the configuration information for cancelling the uplink channel and/or the uplink signal configured by the higher layer; or
the at least one of the downlink channel or the downlink signal configured by the higher layer that is not cancelled includes at least one of a downlink channel or a downlink signal configured by the higher layer that satisfies a predefined time requirement with the configuration information for cancelling the downlink channel and/or the downlink signal configured by the higher layer.

15. The method of claim 4, wherein the reference frequency-domain transmission resource includes frequency-domain transmission resource whose symbol is at least a part of a specific type of signal/channel, and
wherein the specific type of signal/channel includes at least one of:
at least one of a signal or a channel scheduled by DCI,
a synchronization signal/physical broadcast channel,
a physical downlink control channel (PDDCH) in a common search space, or
at least one of a signal or a channel with a predetermined priority.

16. The method of claim 4, wherein in case that the symbol on the first frequency-domain transmission resource is at least a part of a signal with a highest priority or at least a part of a channel with a highest priority, the first frequency-domain transmission resource is determined as the reference frequency-domain transmission resource.

17. The method of claim 1. wherein each of the first frequency-domain transmission resource and the second frequency-domain transmission resource includes at least one of a carrier, a carrier group, a bandwidth part, or a resource block set.

18. The method of claim 1, wherein the method further comprises:
transmitting a physical random access channel (PRACH)through a carrier of at least one of a primary cell or a primary secondary cell when the carrier of the at least one of the primary cell or the primary secondary cell is available, otherwise, transmitting the PRACH through a carrier of a secondary cell.

19. A terminal comprising:
a transceiver configured to transmit and receive signals; and
a controller coupled to the transceiver and configured to:
receive configuration information of a first frequency-domain transmission resource and a second frequency-domain transmission resource, wherein the first frequency-domain transmission resource and the second frequency-domain transmission resource partially overlap or completely overlap in a time domain; and
determine whether to perform at least one of an uplink transmission or a downlink reception on the first frequency-domain transmission resource or the second frequency-domain transmission resource based on the configuration information.

20. A non-transitory computer readable storage medium having one or more computer programs stored thereon, wherein the one or more computer programs, when executed by one or more processors,
control receiving configuration information of a first frequency-domain transmission resource and a second frequency-domain transmission resource, wherein the first frequency-domain transmission resource and the second frequency-domain transmission resource partially overlap or completely overlap in a time domain; and
control determining whether to perform at least one of an uplink transmission or a downlink reception on the first frequency-domain transmission resource or the second frequency-domain transmission resource based on the configuration information.
